(19) United States
(12) Patent Application Publication
(10) Pub. No.: US 2008/0219432 A1
(43) Pub. Date: Sep. 11, 2008

(54) Echo Delay Detector

(75) Inventor: Masoud Ahmadi, London (GB)

Correspondence Address: BARNES & THORNBURG LLP, P.O. BOX 2786, CHICAGO, IL, 60690-2786, US

(73) Assignee: Tecteon pic, London (GB)

(21) Appl. No.: 11/916,171

(22) PCT Filed: May 19, 2005
(86) PCT No.: PCT/GB2006/001858

§ 371 Date: Nov. 30, 2007

(30) Foreign Application Priority Data
Jun. 1, 2005 (GB) 0511159.6

(51) Int. Cl. H04B 3/23; H04B 3/20

(52) U.S. Cl. 379/406.06; 379/406.04

(57) ABSTRACT

An echo detector has a correlator for correlating between an incoming signal and an echo signal, the correlator being arranged to operate recursively, the detector being arranged to detect the echo and the length of its delay from peaks in the correlation. Recursive operation means the computational load can drop from being proportional to N*N, to being proportional to 2N, where N is a number of samples in a correlation window. It also reduces computation delay. A filter at the inputs of the correlator suppresses low frequencies corresponding to the strongest components of pitch in human speech. Such filtering can remove periodic components which can mask a distinct peak of an echo. A classifier thresholds a ratio of highest and next highest correlation peaks beyond a time margin around the highest correlation peak, to reduce erroneous detections. It can classify two or more ratios simultaneously as distinct echoes.

### FIELD OF THE INVENTION

The invention relates to methods and apparatus for detecting delays in echoes, to echo cancellers having such apparatus, to central offices having such echo cancellers for use in telecommunications networks, to methods of providing telecommunications services using the above, to corresponding software and to systems incorporating the above, and methods of using such systems.

### BACKGROUND

There are various known signal processing methods for determining a delay of an echo (also termed echo ranging). As well as being useful for echo cancellation, it is useful in a wide variety of applications such as geology, oceanometry, mobile GSM and CDMA, radar target locating, underwater object location, and in particular at receivers of antenna arrays when multi-path reflections are detected. For the different applications, the principles are the same but implementation requirements or constraints may differ. In case of the geology or seismology, for mapping underground strata for oil & gas sources, speed of processing or calculation complexity are not so important. In contrast, real-time processing is needed for applications such as mobile network antennas, or target location in a radar system. For echo cancellation (EC) of telecommunication signals such as telephone calls, the main constraints are speed of detection and computational load, and at the same time accuracy and reliability are also as important. These requirements make the design very demanding.

Two main factors contribute to the generation of echo: acoustic echo between the earphone and microphone of a telephone set, and electrical echo generated in the transmission systems for the transmit and receive directions of the connection. Hybrid circuits (two-wire to four-wire transformers) located at terminal exchanges or in remote subscriber stages of a fixed network are the principal sources of electrical echo. Subscriber lines in a fixed network are normally two-wire lines for reasons of economy. Interexchange lines, on the other hand, are four-wire lines.

There are two principal known types of delay detection algorithms for such applications, adaptive filtering and algorithms using a subband filter with a sinc function. An example of the former, adaptive filtering for echo delay estimation, or echo location, is shown in Canadian Patent application 02319639 (Popovic). This uses an adaptive filter to model the echo using a downsampled version of the echo source. The adaptive filter generates an aliased transfer function having peaks corresponding to the delay of the echo. An example of the latter is shown in “implementation and evaluation of a real-time line echo bulk-delay estimator” by Ramkumar et al, published in 2000 by IEEE, ref 0-7803-6293-4/00.

Although echo cancellation systems have been implemented without delay detection, it will play an ever more important role in echo canceller (EC) systems for the following reasons. The actual echo delay can be exaggerated by newer cascaded networks. For example in cases of ATM (Asynchronous Transfer Mode) or GSM (Global System for Mobile) networks, the round trip could be 80-200 ms. This would make the echo more pronounced and more noticeable. In such case if the echo tails are delayed beyond the scope of the EC capability, and the EC is not switched off temporarily, it could have very undesirable effects such as distortion, or additional unpleasant sounds, such as howling. In other words the EC as a system may rapidly become unstable.

There are two main objectives in detecting the delay, which are:
determining if the delay is within the required range, so that amongst other things, the EC can be adapted or switched off rapidly if it is out of range, and
if within range, estimating a value within ±τ ms for the echo delay, so that the EC can be adapted more effectively.

The known methods do not achieve these or do not achieve them with sufficiently low computational load, or short processing time, with appropriate accuracy and reliability.

It is known in principle from U.S. Pat. No. 4,577,309 (Barazeche et al.) to use correlation to determine echo delay, but only for the purpose of setting a variable delay in the canceller, and only by adding special autocorrelation signals. U.S. Pat. No. 5,737,410 (Vahatalo et al.) shows correlating speech signals to find the echo delay without adding auto correlation signals. It shows reducing the amount of calculation in such a correlation by using a sliding window of samples. This is achieved by updating the echo signal for each correlation, but not updating the original signal. Thus each succeeding correlation is based on an increasingly delayed version of the original signal. This leads to reduced calculation because a shorter window of samples can be used for the correlation, while still detecting delays much longer in duration than the window, as the window effectively slides with time, compared to the fixed window of samples of the original signal. At longer intervals, this fixed window is updated. This is said to be better than using subsampling to reduce the calculation, since subsampling reduces the accuracy of the delay value.

### SUMMARY OF THE INVENTION

It is an object of the invention to provide improved apparatus or methods. According to a first aspect of the invention, there is provided an echo detector having:

a correlator for determining a correlation between an incoming signal and an echo signal having an echo of the incoming signal, the correlator being arranged to operate recursively, using results obtained for preceding correlation values for determining a current correlation value, and
the detector being arranged to detect the echo from peaks in the correlation.

An advantage of the recursive arrangement is that a dramatic drop in computational load is possible. In one example, the amount of calculation drops from being proportional to N*N, to being proportional to 2N, where N is a number of samples in a correlation window. N can be a value in the order of hundreds in a typical application.

Consequently there may be a corresponding reduction in computation delay. Depending on the recursive algorithm, the load may now be proportional to the number of samples correlated, rather than the square of the number of samples. Again, depending on the recursive algorithm, there may be some loss of accuracy, especially in the first few frames if the algorithm produces an approximated correlation value rather than precisely the same result as a non recursive algorithm. For many applications, the dramatic drop in computational load, and thus faster output of results is much more valuable.

As an additional preferred feature, the correlator is arranged to derive a current correlation component by correlating a current sample value s(n) of the echo signal and a window of samples of the incoming signal. This feature helps enables the computational load to be kept low, by reducing the number of multiplications.

As an additional preferred feature, the correlator is arranged to determine a current correlation output by adding to the current correlation component a factor based on a preceding correlation output. This also helps enable the computational load to be kept low by reusing results.

As a preferred additional feature, the correlator recursive algorithm is

CCF|ₙ=1/Q(Y|ₙ·s(n))+(1−1/Q)CCF|₍ₙ₋₁₎

where s(n) is the current echo signal

Y|ₙ=y(n)+y(n−1)+ . . . +y(0)

and

CCF|ₙ=ccf(n)+ccf(n−1)+ . . . +ccf(0) n=0, 1, 2, . . . , N−1

and Q is a constant determining how much of a preceding correlation output (CCF) is used.

As another preferred additional feature, the incoming signal is subsampled. This also helps reduce the computational load.

As another preferred additional feature, the correlation is updated at a lower rate than a sampling rate of the incoming signal. Again this helps reduce the computational load.

As another preferred additional feature, the detector has one or more filters for suppressing low frequencies in the inputs to the correlator.

As another preferred additional feature, the detector is arranged to determine one or more echo delay values and a classification indicating whether an echo has a peak which is sufficiently distinct and has a delay value suitable for cancellation.

According to another aspect of the invention, there is provided an echo detector having:

a correlator for determining a correlation between an incoming signal and an echo signal having an echo of the incoming signal, and
a filter for suppressing low frequencies corresponding to the strongest components of pitch in human speech in at least one of the incoming signal and the echo signal, the detector being arranged to detect the echo from peaks in the correlation.

An advantage of such filtering is that such low frequencies contain periodic components which can cause undesirable multiple peaks in the correlation. Such multiple peaks may mask a distinct peak of an echo. They could cause an erroneous output indicating no echo, when there is an echo or echoes. Or, if an echo is indicated, the multiple peaks could cause a wrong echo delay to be output.

As another preferred additional feature, such low frequencies are suppressed in both the incoming signal and the echo signal. An advantage of this is that it can help to suppress correlation of harmonics of the periodic signals.

As another preferred additional feature, the low frequencies are those below approximately 2 kHz. An advantage of this level is that is suppresses periodic components from not only the strongest components of pitch in human speech, but also from the most frequently used telecommunications signalling tones.

As another preferred additional feature, the filtering is combined with anti aliasing filtering for suppressing high frequencies for anti aliasing related to the subsampling.

According to another aspect of the invention, there is provided an echo detector having:

a correlator for determining a correlation between an incoming signal and an echo signal, and
a classifier for using the correlation to identify a highest correlation peak and a next highest correlation peak beyond a time margin around the highest correlation peak, and classify the echo based on these correlation peaks.

An advantage of a margin is that it can help avoid erroneous detections or erroneous non detections. Often an echo can cause several peaks in the correlation. Such a classifier arranged to identify distinct peaks in the correlation can enable accurate classification with relatively low computational load, and short time delay before the classification result is output.

As a preferred additional feature, the classifier is arranged to determine a ratio of the magnitudes of the peaks in the correlation.

As a preferred additional feature, the ratio is compared to a threshold.

As a preferred additional feature, the classifier is arranged to classify whether an echo has a peak which is sufficiently distinct and has a delay value suitable for cancellation.

As a preferred additional feature, the detector is arranged to detect a number of echoes simultaneously, and the classifier is arranged to identify a series of the highest peaks in the correlation, disregarding peaks not separated by a time margin, and determine a ratio of magnitudes between each pair of successively smaller peaks in the series.

This can enable multiple echo delay values to be generated, which can be used to further improve echo cancellation.

Another aspect provides an echo canceller having:

a correlator for determining a correlation between an incoming signal and an echo signal, and
a classifier for using the correlation to identify the highest peaks in the correlation, and classify two or more of them simultaneously as distinct echoes, based on these correlation peaks, and
an adaptive canceller for suppressing the echo in the echo signal, according to the output of the classifier. An advantage of this is that the canceller can efficiently focus on the area where the echoes are. This enables the adaptive canceller to have a shorter window or frame, and so faster convergence can be achieved.

As a preferred additional feature, the classifier is arranged to determine a delay value for each of the distinct echoes. This can help the subsequent cancellation.

As a preferred additional feature, the classifier is arranged to identify a series of the highest correlation peaks, disregarding peaks not separated by a time margin, and determine a ratio of magnitudes between each pair of successively smaller peaks in the series.

Another aspect provides an adaptive echo canceller having such an echo detector. As a preferred additional feature, the canceller is arranged to be suppressed depending on an output of the echo detector.

As a preferred additional feature, the canceller is arranged to adapt depending on an output of the echo detector. As a preferred additional feature, the canceller has an adaptable range of echo delay, the range being adaptable depending on an output of the echo detector.

As a preferred additional feature, the detector or the echo canceller is in the form of software. This recognises the value of software as a component which may have great value and be independently traded, separately to hardware components.

Another aspect of the invention provides central office apparatus having the above echo canceller. Another aspect of the invention provides a method of providing a telecommunications service to subscribers, over a network, and using the above central office apparatus.

Other aspects provide for methods or software corresponding to any of the apparatus or system aspects, or combinations or components of the above aspects. Other advantages than those set out above may be apparent to those skilled in the art, particularly over other prior art of which the inventor is not yet aware. The features of dependent claims within each aspect can be combined with each other or with other aspects of the invention as would be apparent to those skilled in the art.

### BRIEF DESCRIPTION OF THE FIGURES

Embodiments of the invention will now be described with reference to the figures as follows:

FIG. 1 shows in schematic form echo cancellers in a known network,

FIG. 2 shows in schematic form an arrangement of an echo canceller having a delay detector,

FIG. 3 shows a delay detector, according to an embodiment of the invention, using a recursive correlation algorithm,

FIG. 4 shows a delay detector according to another embodiment, having a filter for suppressing periodic components of the signals,

FIG. 5 shows a delay detector according to another embodiment, having a classifier,

FIG. 6 shows more details of a delay detector implementation according to another embodiment,

FIG. 7 shows more details of an implementation of the recursive algorithm shown in FIG. 6, and

FIG. 8 shows an example of how to implement a classifier for processing the correlation results.

### DETAILED DESCRIPTION

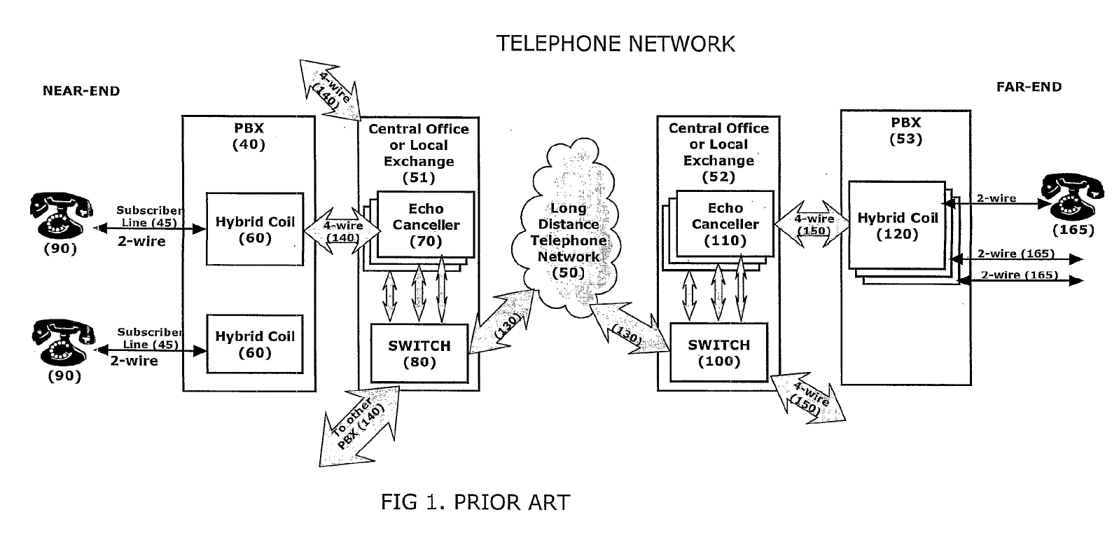

### FIG. 1, Showing how Echo Cancellers are Used in Conventional Telephone Networks

FIG. 1 shows an application of the echo canceller of the invention in a conventional telephone network. In this figure, a long-distance telephone network 50 is shown, for making a telephone call from one subscriber to another. For convenience, one side of the network is denoted the near end, and the other side is denoted the far end. A subscriber's handset 90 is coupled to a private branch exchange (P B X) by a 2-wire subscriber line 45. In the P B X, a hybrid coil 60 is used to convert between the two wire subscriber line and a 4-wire line to the Central Office or local exchange 51. The conversion to 4-wire enables the voice signals in two directions to be a separated, which is useful for digitising and further processing. Each P B X may support tens or hundreds of subscribers, and will have sufficient hybrid coils according to how many calls are to be supported simultaneously.

Connections from many PBXs and many subscriber lines may be concentrated at a Central Office 10, which maybe many miles away from the subscriber. The central office contains the echo canceller 70, and a switch 80. For the sake of clarity, many other functions of the Central Office are not illustrated. There may be many echo cancellers provided, according to how many calls are to be handled simultaneously. Conventionally, each Central Office concentrates many calls on to one or more or trunk routes 130 which make up the long distance telephone network 50. At the far end, similar elements and functions are provided. A far end Central Office 52 contains an echo canceller 110 and a switch 100. 4-wire lines 150 are provide to connect the Central Office to one or more P B Xs 53. Each will contain a hybrid 120. Two-wire subscriber lines 160 couple handsets 165 to the hybrid.

As the echo cancellers are intended to cancel echoes arising from the hybrids at each end of the circuit, in principle, they can be located anywhere in between the hybrids. They are in practice usually located in a central office where many lines are switched and concentrated. This is convenient to enable them to be shared to make more efficient use of limited processing resource, and for ease of access.

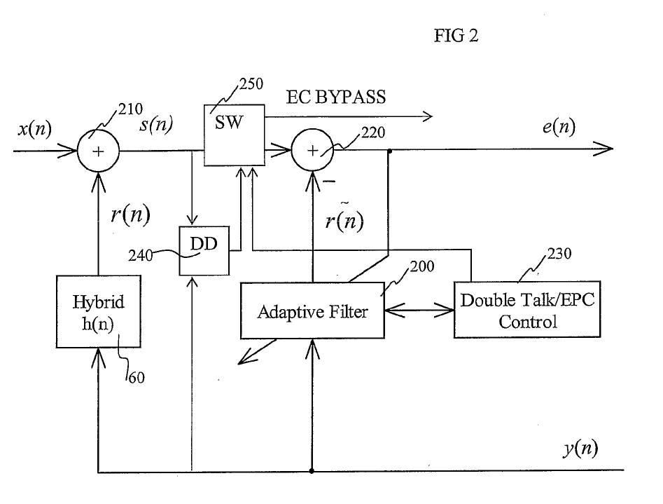

FIG. 2, Showing Principal Elements of an Echo Canceller with a Delay Detector DD

In FIG. 2 a near end signal x(n) has an echo added by a hybrid 60. The hybrid has an impulse response h(n). An adder 210 is shown to represent schematically the addition of the echo r(n) to the near end signal, resulting in an echo signal s(n). The principal elements of the echo cancellor shown in FIG. 2 are an adaptive filter 200, a double talk/EPC (echo path change) control element 230, a delay detector (DD) 240, and bypass switch 250, and a subtractor 220. The adaptive filter creates a model echo r(n) from an incoming signal y(n) also termed a far end signal. The model echo and the echo signal are fed to the subtractor. The model echo is subtracted from the echo signal to produce an echo cancelled signal e(n).

The bypass switch 250 enables the echo signal to bypass the subtractor. This can be achieved by a switch before the subtractor, or a switch after the subtractor, as would be well known to those skilled in the art. The bypass switch is controlled by the delay detector or the double talk/EPC control element. In both cases, the purpose is to avoid or reduce distortion in particular circumstances. Other detectors not shown may also trigger a bypass, such as tone detectors. The delay detector can also be arranged to influence the adaptive filter.

The delay detector is arranged to receive the echo signal from the near end and the incoming signal from the far end. It is arranged to carry out the correlation between these signals to detect echoes and determine echo delays. Some examples of delay detectors will now be described in more detail.

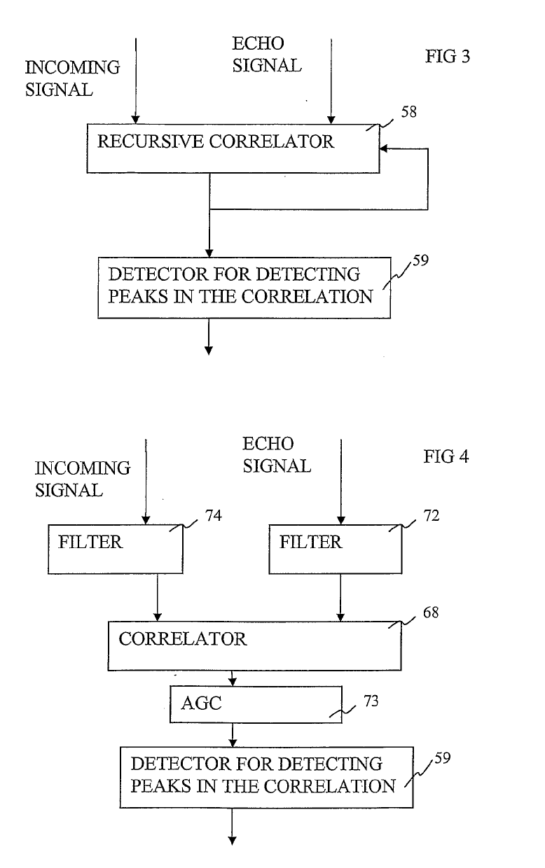

### FIG. 3, Showing an Embodiment of the Delay Detector Having a Recursive Correlator.

FIG. 3 shows in schematic form principal elements of a delay detector according to an embodiment of the invention. This embodiment can be used to implement the delay detector of FIG. 2. The incoming signal and the echo signal are fed to a recursive correlator 58. The output of the recursive correlator is fed to a detector 59 for detecting peaks in the correlation. The output of the recursive correlator is also fed back as another input to the recursive correlator. Each of these elements illustrated may be implemented in various ways, as will be explained in more detail below.

The cross-correlation of the two signals NE and FE is calculated as in following equation for the correlation vector, termed the cross correlation factor ccf.

$$c c f ( k ) {\vert}^{t = τ} = {\sum }_{n = 0}^{N - 1} y ( n ) \cdot s ( n + k )$$

The MIPs (Million Instructions per second) consumption of the above equation is of factor of N (the length of the correlation window, measured in samples), where in our case N=1024, and a sampling rate of 8 kHz, i.e. about 8000 MIPS (1024*1024*8000*10⁻⁶≈8388). In order to reduce the computational the following measures can be taken:

a. Use a recursive algorithm for CCF.
b. Sub-rating (also called decimating) the FE and NE signals by a factor of D.
c. Different updating rate of the correlation, by a factor of M of the decimated samples. In other words, successive correlation windows overlap not by all but 1 decimated sample but by all but M decimated samples.

For example using measures b and c, D=4 and M=2, MIPS consumption will be reduced to {256*256*8000*10⁻⁶/(4*2)≈65}. This is still an unrealistic computational load for many applications. To make above ccf equation realizable a recursive algorithm can be used to make a much greater impact on the computational load. An example of a recursive algorithm now follows:

CCF|ₙ=1/Q(Y|ₙ·s(n))+(1−1/Q)CCF|₍ₙ₋₁₎

where

Y|ₙ=y(n)+y(n−1)+ . . . +y(0)

and

CCF|ₙ=ccf(n)+ccf(n−1)+ . . . +ccf(0) n=0, 1, 2, . . . , N−1

Q is the span factor which represents how much of the preceding ccf to remember. Using this equation will reduce the computation drastically. For example with use of D=4, and M=2, the MIPS consumption will be: {256*2*8000*10⁻⁶/(4*2)≈0.512} which is not only realistic, it is a considerable improvement on other known methods.

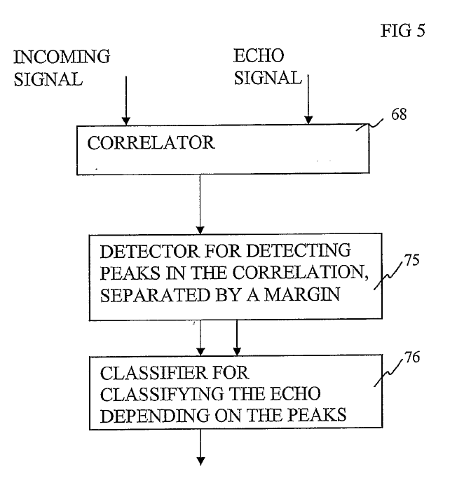

### FIG. 4, Showing an Embodiment of the Delay Detector Having Filtered Inputs.

FIG. 4 shows in schematic form principal elements of a delay detector according to another embodiment. In this case, filters 72, 74 are provided to filter the echo signal and the incoming signal respectively, before they reach the correlator 68. The correlator may be a recursive correlator or a conventional type. The filters are arranged to suppress low frequencies in the incoming signal and the echo signal. The cut-off of these filters is arranged so that periodic components in the signal are suppressed, to reduce the effect of multiple peaks in the correlation caused by such periodic components and their harmonics. For speech signals, typically such periodic components comprise the strongest components of pitch, and are mostly in the frequency range below 1 kHz. If frequencies in the range below approximately 2 kHz are suppressed, then periodic components of the most frequently used telecommunications signalling tones can also be suppressed. The remaining higher frequency signals usually have enough information to enable good echo detection.

An AGC (automatic gain control) arrangement 73 is an optional additional feature. It is particularly useful if filters are used to suppress low frequencies. For voice signals, typically 95% of the energy is in the low frequencies, hence there will be little energy left, and it will fluctuate much more. Hence some form of AGC to adjust the level of the remaining high frequency components can improve performance of later stages. The AGC can be implemented in various ways following established design practice, so there is no need to provide more details here. It is notable that although most of the signal energy is lost in the filtering, typically the higher frequency components still contain most of the information used for understanding the speech.

It is possible to filter one of the inputs only and gain some of the benefit. In practice it preferable to filter both inputs to achieve better suppression of multiple peaks caused by harmonics of the periodic components. The output of the correlator is fed to a detector 59 for detecting peaks in the correlation.

### FIG. 5, Showing an Embodiment of the Delay Detector Having a Classifier.

FIG. 5 shows in schematic form principal elements of a delay detector according to another embodiment. As before, the incoming signal and the echo signal are fed to the correlator 68. The correlation output is fed to a detector 75 for detecting peaks in the correlation. To detect distinct peaks, a time margin around the highest peak is used. A next highest peak outside the time margin is detected. Other peaks within the time margin are disregarded. This takes account of the common situation of an echo causing several closely spaced peaks in the correlation. The widely spaced peaks can represent echoes with widely differing delays. The peaks are fed to the classifier 76 for classifying the peaks. In particular, the classification may include whether the peaks represent an echo which is suitable for cancellation, or periodic signals or other artefacts which might cause the echo canceller to become unstable, or degrade its output.

Again, various implementations of each of these elements are possible, as will be explained in more detail below.

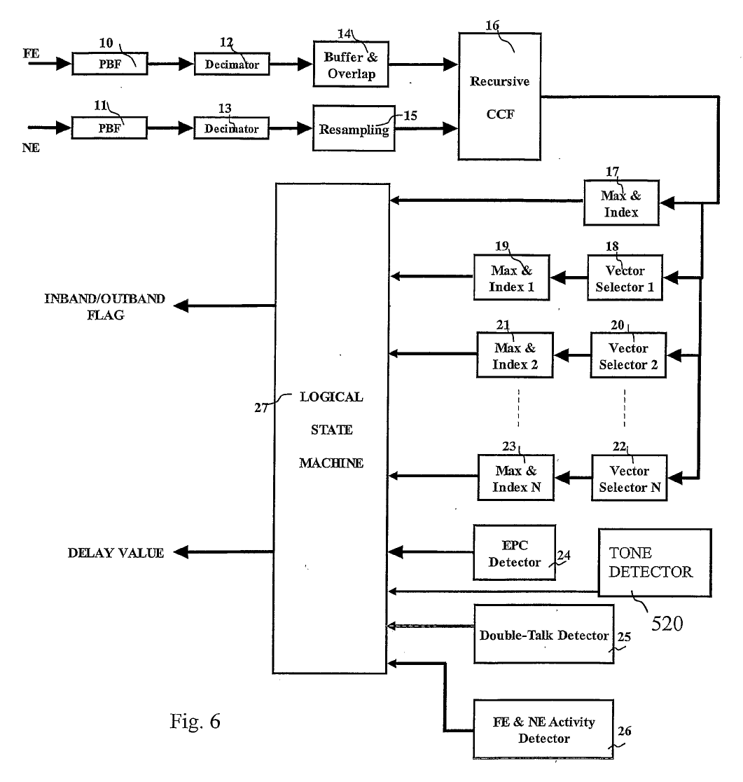

### FIG. 6, Showing a More Detailed View of a Delay Detector.

In FIG. 6, inputs to the delay detector include an echo signal from the near end (NE), and an incoming signal from the far end (FE). The outputs include an inband/outband flag to indicate an echo which is suitable for cancellation, and one or more delay values corresponding to the echo or echoes detected. The echo signal is fed to a decimator 13 (having a decimation factor D, which can be 4 in one example) via a bandpass filter (PBF). The bandpass filter combines the functions of suppressing low frequencies for the purpose of suppressing periodic components as discussed above, together with suppression of high frequencies. The suppression of high frequencies is for the purpose of anti-aliasing associated with the decimation. If the decimation is by a factor of 4, then for an original sampling rate of 8 kHz, becomes a decimated sampling rate of 2 kHz. This enables a frequency range of 1 kHz to be represented without aliasing.

The band of frequencies represented can be 0-1 kHz, or any other band, such as 1-2 kHz or 2-3 kHz as desired. As discussed above, if the band 2-3 kHz is chosen, then the bandpass filter will serve to suppress the lower frequencies to avoid periodic components such as pitch and tones.

The incoming signal is similarly fed to a decimator 12 via a bandpass filter 10. Both signals are fed to a recursive correlator 16 to give a cross correlation factor (CCF). In the case of the incoming signal a buffer and overlap function is provided before input to the correlator. The buffer function enables a window of consecutive samples to be presented as a vector to the correlator. The overlap indicates that consecutive vectors are formed from overlapping windows of samples.

The echo signal is fed to the correlator via a resampling element 15. This reflects the correlation update rate, M which may be lower than the decimated sample rate to reduce the calculation load. No buffering is provided for this signal, since the recursive correlator can operate on just the current sample value of the echo signal, without necessarily needing a vector of consecutive samples. An automatic gain control stage may be provided, (not shown in this figure)

A modulus of the vector produced by the correlator is derived and fed to classifying stages 17-23, 27. The modulus is derived so that positive or negative correlation peaks have the same effect. An updated vector is fed to the classifying stages every M samples. For each vector, first, a maximum and index finder 17, is used for determining a maximum peak in the entire vector, and a corresponding index (which represents the delay at this peak). These are used to control a series of vector selectors 18, 20, 22. These are used to determine the next highest peaks in parts of the correlation away from the highest peak. The vector may be divided into quarters or some other fraction. A first quarter can be centred on the index of the maximum peak, and other quarters or parts of quarters derived from the index of the maximum peak. Vector selectors 18, 20, 22 and so on are each used to carry out this segmentation, and feed the selected part of the vector to their associated maximum and index elements 19, 21, 23.

These elements determine the highest peak in their quarter, or part of the vector, and the corresponding index value. This segmentation of the vector enables search time for the next highest peaks, and computational load to be reduced. The detailed implementation of these elements is a matter of design convenience following established practice.

The outputs of these elements are fed into a logical state machine 27 which determines ratios of magnitudes of successive distinct peaks separated by time margins of R samples. (In a typical example, R=15). The ratios are thresholded, and if they show the ratio is large enough, the echo is flagged as inband. The flag can also show whether more than one distinct peak has been identified. The delay value represented by the index of the respective peak is derived by determining a product of the decimation factor and the index. Where multiple echoes are detected, multiple delay values can be output by the logical state machine.

Optionally, the logical state machine may have other inputs for controlling the flag output. Examples include the EPC detector 24, the double-talk detector 25 and the FE and NE activity detector 26. A tone detector 520 may be useful so that if a tone is detected, the state machine should be disabled or indicate that the correlator output cannot distinguish between echo or no echo. The flags can be arranged to indicate a “don't know” condition, and any delay value will be unreliable in this case. Normally the classifier will show no echo, because the correlator output will not show a sufficiently distinct peak. But this may mask the fact that there is an undetected echo.

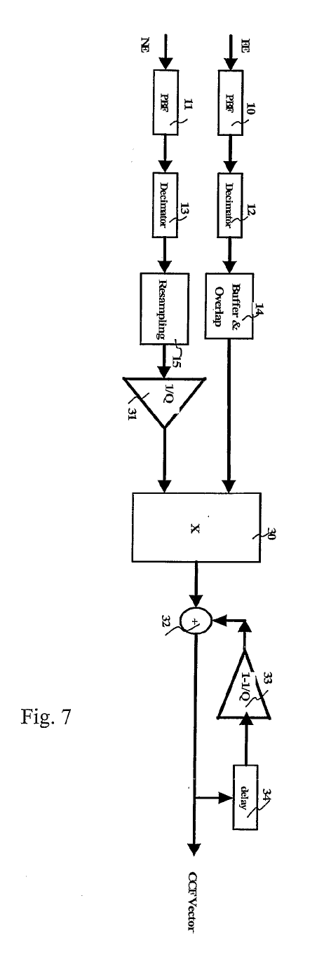

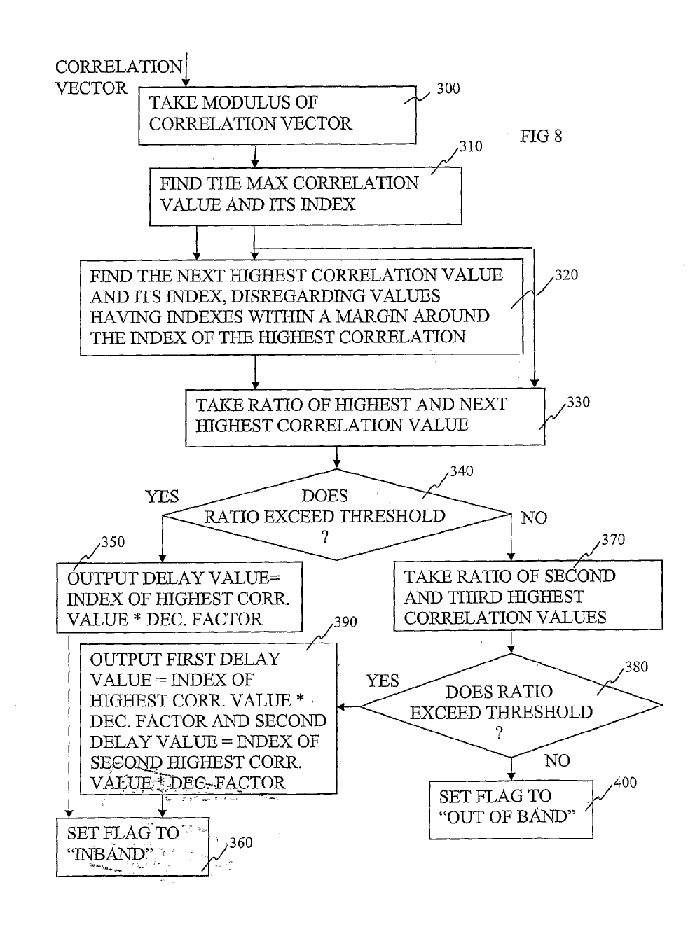

### FIG. 7, Showing a More Detailed View of the Recursive Correlator.

In FIG. 7, reference numerals corresponding to those in FIG. 6 where appropriate. The echo signal and incoming signal are processed as shown in FIG. 6 up to the point where they are input to the recursive correlator. As shown in FIG. 7, the incoming signal in the form of a vector output by the buffer and overlap element 14 is fed to a multiplier 30. The echo signal as output by the resampling element 15 is amplified by a constant factor 1/Q in element 31. This result is fed to the multiplier and multiplied by the incoming signal vector. This produces an instantaneous correlation vector, but only in respect of the current echo signal sample.

Resampling is effectively for synchronising the inputs of the correlator, since the buffer and overlap element introduces a delay. Resampling also effectively decimates the signal further, by a factor of M, to match the reduced rate of the output of the buffer and overlap element.

To correlate a window of echo signal samples with a window of incoming sample signals, the instantaneous correlation vector is added to preceding instantaneous correlation vectors. To achieve this recursive function, an adder 32, an amplifier 33 and a delay element 34 are provided. The instantaneous correlation vector is added to a delayed version of the output of the adder. The delayed version is amplified by a constant factor 1-1/Q before input to the adder. The amplifiers 31 and 33 may be used for AGC purposes as well. The output of the adder 32 may be used to feed an element (not shown) for deriving a modulus of the vector.

### FIG. 8, Showing Operation of the Classifier.

FIG. 8 shows in schematic form some of the principal steps in the operation of a classifier such as that shown in FIG. 6. As shown in FIG. 8, the correlation vector is first fed to a modulus function 300 so that positive or negative correlation peaks are not treated differently. Step 310 takes the modulus and finds a maximum correlation value and its corresponding delay. At step 320 the next highest correlation value is determined disregarding peaks having delays within a margin around the delay value of the highest peak. At step 330, the peaks are classified by taking a ratio of the highest correlation value and the next highest correlation value. At step 340, the ratio is thresholded and if it exceeds a threshold, at step 350, a delay value is derived and output. It is derived by generating a product of the index and the decimation factor D.

At step 360, the flag is set to inband. Although it is possible to look for further peaks, if the threshold ratio is around 1.5 or greater, there will be limited benefit for echo cancellation applications at least, in looking for lower peaks. In contrast, if the threshold is not exceeded, it is more worthwhile looking for the ratio of the two next highest peaks. Hence at step 370, a ratio of the second and third highest peaks is derived. At step 380, it is compared to a threshold, typically but not necessarily the same threshold as before. If the threshold is exceeded this time, two delay values are output at step 390, corresponding to the two highest peaks. As before, they are derived by multiplying the index value corresponding to the peak, with the decimation value D. Also, at step 360, the flag is set to “inband”. If the threshold is not exceeded, the flag is set to “outband”.

In principle, further echoes could be classified and flagged in a similar manner, though with decreasing additional benefit in terms of echo cancellation performance. Other applications may benefit from classifying other weaker echoes.

In other words, the method can be summarised as follows:

a. Take the modules of the CCF vector, i.e. |CCF|
b. Find the max index and the value of the max, CCF_{max1Index} and CCFₘₐₓ₁,
c. Find the second max outside the specific range (R), i.e. CCF|n±R as CCF_{max2Index} and CCFₘₐₓ₂. This is done since if the FE and its delayed echo is present within the search range, an exponential decay behaviour of CCF per hybrid is expected.
d. Calculate the ratio and threshold it: CCF_{max1Index}/CCF_{max2Index}≧RATIO
e. If the statement ‘d’ is TRUE then it is flagged as INBAND otherwise:
f. find the third max outside the specific range (R), i.e. CCF|n±R as CCF_{max3Index} and CCFₘₐₓ₃.
g. Calculate the ratio and threshold it: CCF_{max2Index}/CCF_{max3Index}≧RATIO.
h. If the statement ‘d’ is TRUE then it is flagged as INBAND otherwise flag as OUTBAND.

### Other Variations Comments and Remarks

In a typical application the following parameters can be used for searching for an echo delay of up to 128 ms:

D=2-8, i.e. buffer of 128-512 samples for a window size N of 1024 samples.
M=1-6, i.e. overlap of 250-255 if the buffer is 256 samples.

### Q=512,

### RATIO=1.5-2.1,

R=10-25 samples.

Advantages found for the given settings include the MIPS and memory consumption being very low, i.e. <1 MIPS and memory usage of less than 1 kwords, where the word size depends on the processor. The echo detection is not restricted to echoes of speech, it can encompass echoes of other signals such as pulses or tones for example. The tones can include signalling tones of single or multiple frequencies, or any other types of tones.

The echo canceller can be bypassed depending on the echo detector outputs, or in principle, the echo model input to the subtractor can be suppressed. The adaptive filter can be adapted using the echo delay values, and the correlation peak values, or shape. Additionally, the far end signal can be delayed before input to the adaptive filter, to enable a simpler, faster and more efficient filtering operation.

In another embodiment of the EC, the delay value from the delay detector would play a more important rule since, if echo delays (in other words the EC tails) lie in a different range, say from 128 ms to 256 ms (for example) we can still use the same 128 ms filter length (and thus the same computational load) by just delaying the FE signal by estimated delay and put the 128 ms filter on that region or range. This is valid providing all of the echoes (hybrid(s) tails) are in the given range i.e. 128-256 ms.

The delay detector and the echo canceller and other functions can be implemented in well known programming languages such as C or Ada, or others, as would be well known to those skilled in the art. The resulting code can be cross-compiled into a lower level language appropriate to run on a DSP, such as the fixed or floating point types made by TI or Motorola or others, or on a general purpose microprocessor, or any type of firmware, or programmable or fixed hardware, or any combination. The software can in principle be implemented as instructions or as combinations of data, instructions, rules, objects and so on.

Other variations and implementations within the scope of the claims will be apparent to those skilled in the art, and are not intended to be excluded.

As has been described above, an echo detector has a correlator for correlating between an incoming signal and an echo signal, the correlator being arranged to operate recursively, the detector being arranged to detect the echo and the length of its delay from peaks in the correlation. Recursive operation means the computational load can drop from being proportional to N*N, to being proportional to 2N, where N is a number of samples in a correlation window. It also reduces computation delay. A filter at the inputs of the correlator suppresses low frequencies corresponding to the strongest components of pitch in human speech. Such filtering can remove periodic components which can mask a distinct peak of an echo. A classifier thresholds a ratio of highest and next highest correlation peaks beyond a time margin around the highest correlation peak, to reduce erroneous detections. It can classify two or more ratios simultaneously as distinct echoes.

1. An echo detector having:
a correlator for determining a correlation between an incoming signal and an echo signal having an echo of the incoming signal, the correlator being arranged to operate recursively, using results obtained for preceding correlation values for determining a current correlation value, and
the detector being arranged to detect the echo from peaks in the correlation.

2. The detector of claim 1, the correlator being arranged to derive a current correlation component by correlating a current sample value s(n) of the echo signal and a window of samples of the incoming signal.

3. The detector of claim 2, the correlator being arranged to determine a current correlation output by adding to the current correlation component a factor based on a preceding correlation output.

4. The detector of claim 1, the recursive operation being based on the relationship
CCF|ₙ=1/Q(Y|ₙ·s(n))+(1−1/Q)CCF|₍ₙ₋₁₎
where s(n) is the current echo signal
Y|ₙ=y(n)+y(n−1)+ . . . +y(0)
and
CCF|ₙ=ccf(n)+ccf(n−1)+ . . . +ccf(0) n=0, 1, 2, . . . , N−1
and Q is a constant determining how much of a preceding correlation output (CCF) is used.

5. The detector of claim 1, and having an arrangement for subsampling the incoming signal.

6. The detector of claim 1, the correlator being arranged to output an updated correlation at a lower rate than a sampling rate of the incoming signal.

7. The detector of claim 1, the detector having one or more filters for suppressing low frequencies in the inputs to the correlator.

8. The detector of claim 1, being arranged to determine one or more echo delay values and a classification indicating whether an echo has a correlation peak which is sufficiently distinct from other correlation peaks and has a delay value suitable for cancellation.

9. An adaptive echo canceller having an echo detector as set out in claim 1.

10. The canceller of claim 9, arranged to suppress cancellation depending on an output of the echo detector.

11. The canceller of claim 9, arranged to adapt depending on an output of the echo detector.

12. The canceller of claim 9 and having an adaptable range of echo delay, the range being adaptable depending on an output of the echo detector.

13. An echo detector having:
a correlator for determining a correlation between an incoming signal and an echo signal having an echo of the incoming signal, and
a filter for suppressing low frequencies corresponding to the strongest components of pitch in human speech in at least one of the incoming signal and the echo signal, the detector being arranged to detect the echo from peaks in the correlation.

14. The detector of claim 13 having filters for suppressing such low frequencies in both the incoming signal and the echo signal.

15. The detector of claim 13, the low frequencies being those below approximately 2 kHz.

16. The detector of claim 13, and having a subsampler and a combined filter for anti aliasing related to the subsampling and for suppressing the low frequencies.

17. An adaptive echo canceller having the echo detector of claim 13.

18. The canceller of claim 17, arranged to suppress cancellation depending on an output of the echo detector.

19. The canceller of claim 17, arranged to adapt depending on an output of the echo detector.

20. An echo detector having:
a correlator for determining a correlation between an incoming signal and an echo signal, and
a classifier for using the correlation to identify a highest correlation peak and a next highest correlation peak beyond a time margin around the highest correlation peak, and classify the echo based on these correlation peaks.

21. The detector of claim 20, the classifier being arranged to determine a ratio of the magnitudes of the peaks in the correlation.

22. The detector of claim 21, arranged to compare the ratio to a threshold.

23. The detector of claim 20, the classifier being arranged to classify whether an echo has a correlation peak which is sufficiently distinct from other correlation peaks and has a delay value suitable for cancellation.

24. The detector of claim 20, arranged to detect a number of echoes simultaneously, and the classifier is arranged to identify a series of the highest peaks in the correlation, disregarding peaks not separated by a time margin, and determine a ratio of magnitudes between each pair of successively smaller peaks in the series.

25. An adaptive echo canceller having the echo detector of claim 20.

26. The canceller of claim 25, the cancellation being suppressed depending on an output of the echo detector.

27. The canceller of claim 25, being arranged to adapt depending on an output of the echo detector.

28. An echo canceller having:
a correlator for determining a correlation between an incoming signal and an echo signal, and
a classifier for using the correlation to identify the highest peaks in the correlation, and classify two or more of them simultaneously as distinct echoes, based on these correlation peaks, and
an adaptive canceller for suppressing the echo in the echo signal, according to the output of the classifier.

29. The canceller of claim 28, the classifier being arranged to determine a delay value for each of the distinct echoes.

30. The canceller of claim 28, the classifier being arranged to identify a series of the highest correlation peaks, disregarding peaks not separated by a time margin, and determine a ratio of magnitudes between each pair of successively smaller peaks in the series.

31. The canceller of claim 28, the cancellation is arranged to be suppressed depending on an output of the echo detector.

32. The canceller of claim 28, the canceller being adaptive and arranged to adapt depending on an output of the echo detector.

33. The canceller of claim 28, arranged to have an adaptable range of echo delay, the range being adaptable depending on an output of the echo detector.

34. The detector of claim 1 in the form of software.

35. The detector of claim 13 in the form of software.

36. The detector of claim 20 in the form of software.

37. Central office apparatus having the echo canceller of claim 9.

38. A method of providing a telecommunications service to subscribers, over a network, and using the central office apparatus of claim 38.

39. Central office apparatus having the echo canceller of claim 17.

40. A method of providing a telecommunications service to subscribers, over a network, and using the central office apparatus of claim 39.
